(19) United States
(12) Patent Application Publication
(10) Pub. No.: US 2006/0042549 A1
(43) Pub. Date: Mar. 2, 2006

(54) Animal feeder

(76) Inventor: Robert P. Bauman, Burlington, NC (US)

Correspondence Address: HARNESS, DICKEY & PIERCE, P.L.C., P.O. BOX 828, BLOOMFIELD HILLS, MI, 48303, US

(21) Appl. No.: 11/211,017

(22) Filed: Aug. 24, 2005

Related U.S. Application Data
(60) Provisional application No. 60/605,184, filed on Aug. 27, 2004.
(60) Provisional application No. 60/611,910, filed on Sep. 21, 2004.

(51) Int. Cl. A01K 5/01; A01K 1/10

(52) U.S. Cl. 119/61.57

(57) ABSTRACT

An animal feeding/watering system includes a first panel which mounts against an exterior facing side of an animal enclosure wall. A first panel aperture aligns with a species specific access aperture positioned as desired in the enclosure wall. A second panel, apertures and mounting holes mirroring the first panel's, mounts on an interior facing side of the enclosure wall and fixes the apertures in alignment via fasteners to panel one. A feeding unit outside the animal enclosure reversibly mounts to panel one below and aligned with its aperture. A door mounted on the first panel latches closed to cover the aperture thereby preventing animal-human contact while filling the feed unit and is opened to permit one animal to access the feed unit. Shutters adjustably fixed to the second panel customize the aperture area to accommodate each species' method of accessing the feed unit and prevent escape.

### CROSS-REFERENCE TO RELATED APPLICATIONS

This application claims the benefit of the U.S. Provisional Application No. 60/605,184, filed on Aug. 27, 2004 and the U.S. Provisional Application No. 60/611,910, filed on Sep. 21, 2004. The disclosures of the above applications are incorporated herein by reference.

### FIELD OF THE INVENTION

The present invention relates in general to creature and/or animal feeding systems and more specifically to an animal feeder system connectible to an animal enclosure.

### BACKGROUND OF THE INVENTION

Animals are commonly kept within enclosures such as kennels, barns, cages, and the like which provide a living area for the animal and generally control the area the animal can roam. As used herein the terms “feed” or “feeding” also include providing fluids such as water, and the term “feed unit” also includes fluid or water units. Feeding animals within an enclosure commonly requires opening an access in the containment wall and either directly entering the enclosure or hand passing a feed unit such as a bowl into the enclosure. Feeding or watering can also be performed by filling a feed unit positioned outside the enclosure, which the animal has direct access to via an opening in the enclosure.

The process of an individual feeding animal(s) maintained within an enclosed area via either directly entering the enclosure or hand passing a feed unit such as a bowl into the enclosure is generally very time consuming, can lead to injury to the individual or soiling of their clothes, and can lead to escape of the animal(s) from the enclosure. Furthermore, feeding multiple animals within the same enclosure generally requires a method of physically restraining the animals while they eat with chains or other means to avoid fighting for the other animal's food. In some circumstances, such as when the animal or animals are violent by nature, for example specially trained dogs such as police or attack dogs, the feeding process can require specially trained individuals and/or protective gear to accomplish feeding. Sick, injured or potentially rabid animals hospitalized in a veterinarian hospital present heightened risk to attendants when accessing the animal's enclosure to accomplish feeding. Common feeding designs, particularly where the feed unit is positioned outside of the enclosure, provide no method to accommodate different sized animals, for example different breeds or young versus adult animals, therefore unduly restricting access for the larger animals or permitting access for the larger animals which can prevent the smaller/younger animals from accessing the food.

It is therefore desirable to provide a system to feed and/or water animals kept within an enclosure that maintains a boundary between animals in the same enclosure during feeding, maintains a boundary between the animal(s) and the person performing the feeding/watering, accommodates a wide variety of animal species and sizes and installs to preexisting animal enclosures.

### SUMMARY OF INVENTION

According to some embodiments an animal feeder includes a first panel connected to an exterior facing side of an animal enclosure containment wall. A first panel aperture is aligned with a slightly larger access aperture created in the containment wall. A door mounted on the first panel is aligned in a closed position to cover the first aperture, and is opened to permit an animal to access food or water outside the enclosure via a plurality of species dependent features exemplified by but not limited to an animal's head and neck, an extremity, a specialized feeding appendage or a specialized feeding tool.

According to other embodiments, a second aperture of a second panel configured substantially as a mirror image to that of the first panel and its aperture is aligned with the apertures of both the first panel and the animal containment wall. The second panel is positioned on an opposite interior facing side of the containment wall from the first panel. At least one aperture shutter can be used to vary the second panel aperture cross sectional area to mitigate against escape of different sized animals. Height and width of the first and second panels and access apertures may vary in dimensions to accommodate or exclude a specific animal species or size of animal.

According to still further embodiments, an attachment device is connected to the first panel to releasably retain an animal feeding unit in a specified relationship to the door and thereby the apertures to facilitate species specific feeding or accommodate a plurality of species. The attachment device can be an elastically deflectable polymeric strap or a preformed holder. Adjustable brackets or mounting devices can also be positioned above and/or below the feeding unit to accommodate a plurality of available feeding units and temporarily fix the location of the feeding unit to prevent the animal from removing or displacing the unit.

An animal feeder of the present invention provides several advantages. By creating an aperture in the containment wall of an animal enclosure and providing a door accessible from the outside the enclosure, an animal can be fed or watered by an individual without entering the enclosure, thereby preventing direct contact with the animal and possible injury and/or soiling of the individual. Separation between the feeding units permits simultaneous feeding of multiple animals sharing the same enclosure, since hunger and competition continuously directs each animal's mouth into a feed unit located outside the enclosure by design and one animal can't bite the other with their mouth outside the enclosure (species dependent). Aperture shutters permit the cross sectional area of the feeding aperture to be adjusted to prevent escape for a plurality of animal species and sizes without changing the fixed apertures of the panels or barrier wall. A feed unit such as a food bowl is releasably mounted below the door to permit the container to be easily removed, cleaned and/or filled with food/water. The retaining system for the feed unit accepts most commercially available animal feeding bowls. The external access door can be latched closed to prevent injury to the attendant when the feeding unit is being filled or removed for cleaning. Furthermore, the latch can be locked in the closed position between feedings to prevent unlatching by the animal attempting to access retained food or destroy the feed unit or its retainer in the absence of an attendant. Similarly, the latch can be locked in the opened position to assure continuous access to food and/or water. Fixing the relationship between the feed container unit and the exterior panel aperture provides unlimited choice of an installation height for each feed unit which can further separate a plurality of animal species and animal sizes sharing the same enclosure during feeding. For example, shutter control of the aperture area can prevent a grown animal from accessing the food of a smaller offspring or a larger species from accessing the food of a smaller species, while raising the mounting height of the larger animal's feed unit prevents the smaller animals from accessing the larger aperture of the elevated feeding unit, thereby preventing their escape (species dependent). Materials and construction of the animal feeder are selected to protect the animal while feeding and withstand the persistent destructive behavior commonly expressed by a large, bored, unsupervised animal between feedings.

Further areas of applicability of the present invention will become apparent from the detailed description provided hereinafter. It should be understood that although detailed descriptions and specific examples are directed toward accomplishing feeding, the feeding device is equally suited for watering of animal(s) and does not require conditional or additional description to accomplish this intended application. Furthermore, it should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully defined from the detailed description and the accompanying drawings, wherein:

FIG. 1 is a front perspective view of an animal feeding device of the present invention;

FIG. 2 is an exploded perspective view of the animal feeding device of FIG. 1;

FIG. 3 is a front elevational view of a first panel of the animal feeding device of FIG. 1;

FIG. 4 is a front perspective view of a second panel of the animal feeding device of FIG. 1;

FIG. 5 is a front exploded view of the shutter elements for the animal feeding device of FIG. 1;

FIG. 6 is a side elevational view of a shutter extension;

FIG. 7 is a front elevational view of an exemplary shutter element of the present invention before forming of the protective end bend;

FIG. 8 is a side plan view of the shutter of FIG. 7 with the protective bend;

FIG. 9 is a front elevational view of an upper mount of the present invention;

FIG. 10 is a side elevational view of the upper mount of FIG. 9

FIG. 11 is a front elevational view of a lower mount of the present invention; and

FIG. 12 is a side elevational view of the lower mount of FIG. 11.

### DETAILED DESCRIPTION

The following description of several embodiments of the invention is merely exemplary in nature and is in no way intended to limit the invention, its application, or uses.

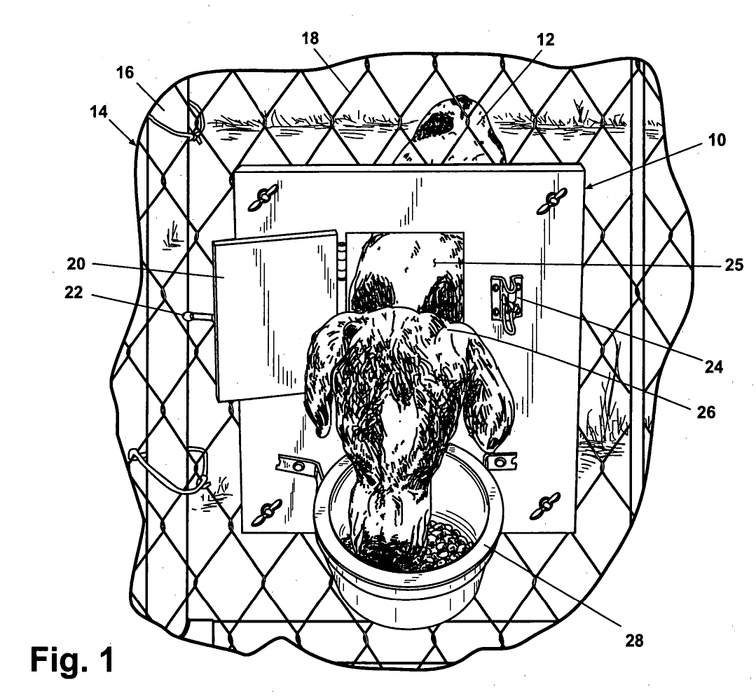

In accordance with several embodiments of the present invention and referring generally to FIG. 1, an animal feeding device 10 is adapted for permitting an animal 12, which is normally housed in an animal enclosure 14 such as a fenced kennel to be fed without directly exposing a person to animal 12. In the example shown, animal enclosure 14 includes wall structure 16 such as a plurality of metal tubes or posts. A barrier 18 such as a wire linked fence is connected to the wall structure 16 to contain animal 12. The animal feeding device 10 is equally effective and applicable in feeding and watering of animals enclosed within a non-perforated solid wall structure.

Animal feeding device 10 is connected to a portion of barrier 18 and includes a door 20 which is movable between a closed position and an open position shown by releasing a latch bar 22 from a latch 24 by the person providing food for animal 12. An additional latch (not shown) similar in function to latch 24 can also be provided to latch door 20 in an open position. Latch 24 can also be locked for example by attaching a lock, pin or similar device in latch 24 such that latch bar 22 can be prevented from release from latch 24 or prevented from latching with latch 24. This provides for each of a locked closed and a locked open position for door 20. An envelope or opening cross sectional area 25 provided by the creation of door 20 permits the animal to access the feed unit. Animal 12 is a dog in this example but could represent any other ambulatory animal retained within an enclosure.

The animal extends a head/neck 26 through the barrier 18 to access a feeding unit 28, which in the example shown is a dog food bowl of standard design. The term “head/neck” as used herein also applies to other appendages and special devices or tools extended through the barrier 14. For example, other species may feed via extending an appendage such as a hand, arm or special device such as a straw or tool through animal enclosure 14 to access a suitable feeding unit 28 and retrieve the food for consumption within the enclosure. Dimensions of the access apertures and door 20 are selected to suit the feeding methods of the animal species intended for use of animal feeding device 10 and to protect the individual feeding the animals 12 and reduce the possibility of escape of the animal(s) 12. Similarly, a height and width of an animal feeding device 10 can also be varied from that shown to accommodate the required dimensions of the feeding apertures suited to a size, type and/or behavioral characteristic of animal 12.

It is noted that animal enclosure 14 shown in FIG. 1 is exemplary of a plurality of designs for holding areas. Wall structure 16 and barrier 18 are shown for exemplary purposes only and can be replaced by alternate structure and/or fencing materials such as but not limited to wooden posts and horizontally extending fence members, solid walled enclosures, livestock pens, cages, animal shelters such as but not limited to dog and/or cat houses, and the like. Use of door 20 provides the handler or person direct access to feeding unit 28 with door 20 in the closed and latched position preventing animal 12 from reaching the person or the feeding unit until door 20 is manually opened. A plurality of animal feeding devices 10 can be disposed along a length of barrier 18 to permit individualized feeding of multiple animals 12 of similar size and methods of feeding, simultaneously (species dependent). For the example of a dog, animal feeding device 10 provides for each animals' safety during feeding because one animal cannot bite another animal while head/neck 26 is extended through feeding area 25 and external to the animal enclosure 14 containing the animal(s). Furthermore, since the relationship between the feeding area 25 and the feed unit 28 is fixed in the device 10, the height of one or more animal feeding device(s) 10 on the containment wall may be chosen to further separate and individualize feeding of differing animal species, differing sizes, and/or differing food requirements while sharing the same containment area.

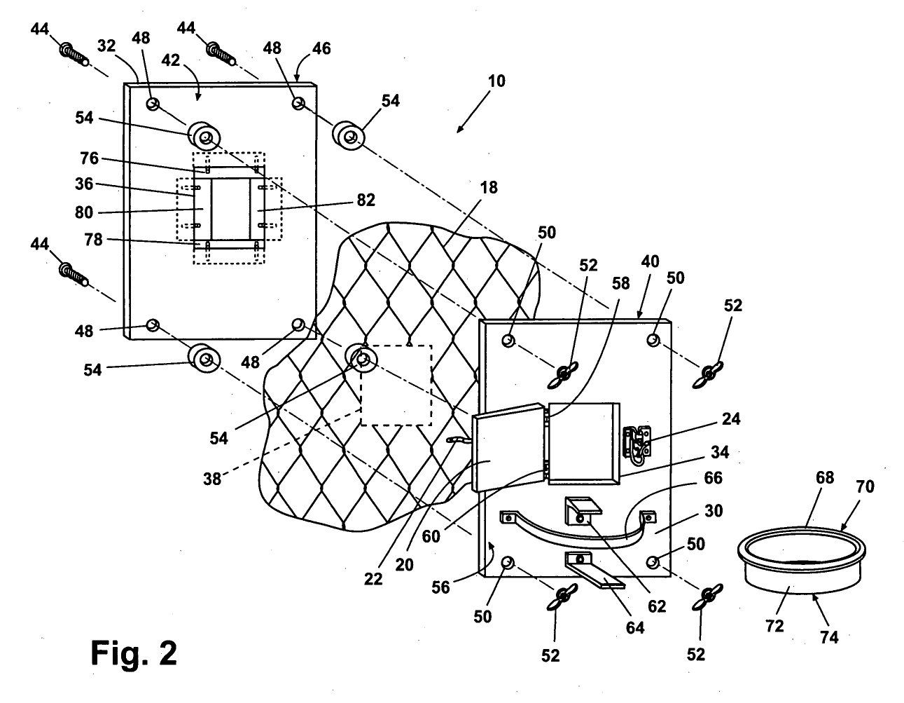

Referring next to FIG. 2, animal feeding device 10 further includes a first panel 30 disposed on an outward facing side of barrier 18. A second panel 32 is disposed on an inward or animal facing side of barrier 18. First panel 30 is provided with a feeding area 25, which in some embodiments results from the creation of door 20. An envelope or cross sectional area of feeding area 25 is selected to permit the intended animal 12 to access the feed container to feed in a manner suitable to their species. In the example provided feeding area 25 provides sufficient area to permit the head/neck 26 of animal 12 (dog) to extend therethrough. Similarly, second panel 32 provides a second aperture 36 similarly sized with first aperture 34 for the same purpose. An access aperture 38 is also cut or otherwise created in barrier 18 or any other containment wall structure. The size of access aperture 38 at a minimum equals the size of each of first and second apertures 34, 36, but can also be made slightly larger, without exceeding the dimensions of first or second panels 30, 32 so that potentially damaging edges of barrier 18 or other barrier can be isolated from animal 12 by centering the apertures of the first and second panels 30, 32 with the access aperture 38. Post cut smoothing of the aperture borders of the containment wall can further protect the animal's skin during feeding and especially during unexpected rapid withdrawal of the animal from the apertures.

First panel 30 is positioned having a holding area facing side 40 contacting barrier 18. Similarly, an outward facing side 42 of second panel 32 is abutted against barrier 18. A plurality of fasteners 44 are inserted for example from an inward facing side 46 of second panel 32 extending through an alignment aperture 48 of second panel 32, through barrier 18, and subsequently through one of a plurality of aligned receiving apertures 50 of first panel 30. A retention element 52 such as a nut which is shown for example as a wing-nut is connected to a fastener 44 to retain animal feeding device 10 in a substantially fixed position with respect to barrier 18 and access aperture 38. A spacer 54 can also be provided between first and second panels 30, 32, for each fastener 44 to accommodate a thickness of barrier 18 if desired.

A plurality of components is also provided on an operator facing side 56 of first panel 30. These components include a first and second hinge 58, 60 which movably or rotatably support door 20, an upper mount 62, a lower mount 64 and an attachment device 66. An animal feeding unit 68 which in this example is shown as a food bowl is positioned between upper and lower mounts 62, 64 and biased into a contact position with first panel 30 using attachment device 66. In one embodiment shown, upper and lower mounts 62, 64 are L-shaped brackets and attachment device 66 is a strap of polymeric material which can stretch elastically to permit installation and removal of animal feeding unit 68. Attachment device 66 can also be provided as a predetermined sized structure coinciding with dimensions of animal feeding unit 68. In other embodiments, attachment device 66 is a spring material made of metal or polymeric material, a bracket made of polymeric or metal material, or similar device operable to retain animal feeding unit 68 proximate to door 20 for feeding animal 12. Attachment device 66 retains the animal feeding unit at a predetermined position aligned with and below door 20. In the example shown, animal feeding unit 68 includes an open-end wall 70, a body 72 and a closed end surface 74. When installed, animal feeding unit 68 is in contact at open-end wall 70 with upper mount 62 and closed end surface 74 is at least partially supported by lower mount 64. Attachment device 66 is positioned about body 72 to restrain motion of animal feeding unit 68.

A plurality of shutter elements 76, 78, 80, and 82 are connectible to second panel 32. Shutter elements 76, 78, 80 and 82 are adjustably positioned to control an open cross sectional area of second aperture 36 (substantially equal to or less than the cross sectional area 25 of first aperture 34). Control of the open cross sectional area permits entry of an animal appendage used for feeding, such as head/neck 26 shown in the example arrangement, while preventing the animal 12 from escaping the enclosure through the larger apertures of panels 30, 32 and containment barrier 18. Whereas the larger apertures of first and second panels 30, 32 and containment barrier 18 determine the maximum animal size (species dependent) that animal feeding device 10 can accommodate, the shutter controlled entry aperture of second panel 32 determines the smallest animal (species dependent) that each animal feeding device 10 can prevent escaping thereby broadening the application of each animal feeding device 10 with fixed panel apertures across a plurality of animal species and sizes. Mounting multiple feeding devices 10 of similar dimensions at differing heights along an barrier 18 may facilitate additional separation and applicability across species and animals of differing size such as a canine mother and offspring sharing the same enclosure via fixing the mother's feeding device 10 above the reach of the offspring and the offspring's feeding unit 10 fixed in the barrier 18 at a level suitable for access by the smaller offspring while adjusting the shutter controlled aperture to prevent escape of the offspring and prevent access of the larger mother's head to access the offspring's food.

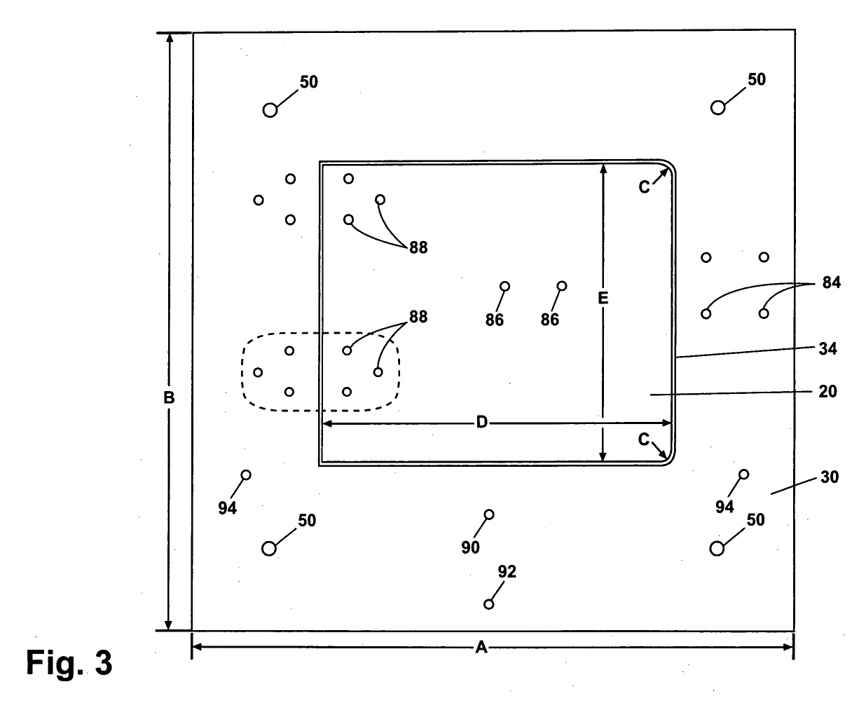

Referring now generally to FIG. 3, dimensions of first aperture 34 in first panel 30 are selected to permit a plurality of desired species and animal sizes to access feed or water outside the animal enclosure through the aperture. First panel 30 also includes a first panel length “A”, and a first panel width “B”, which are selected to accommodate the size of aperture 34 and provide sufficient assembly strength to prevent a plurality of animal species of varying strength and behavior from breaking or dislodging the panel to escape the enclosure. In some embodiments, door 20 is cut or otherwise removed from the material of first panel 30 thereby defining the cross sectional area 25 of first aperture 34. A molding process can also be used to create panel 30 and first aperture 34, thereby defining the dimensions of door 20 cut from stock or molded in a manner similar to panel 30. A door corner radius “C” can also be provided at selected corners of door 20 to provide rounded surfaces, which the animal 12 or operator might contact. First aperture 34 includes a first aperture length “D” and a first aperture width “E”. In one embodiment, both first aperture length “D” and first aperture width “E” are 7 inches (17.78 cm). First panel 30 further includes a plurality of latch fastener apertures 84 which are sized and located to provide fastener support for latch 24. At least one latch bar fastener 86 is provided through door 20 to fastenably support latch bar 22 aligned to permit latch bar 22 to freely engage and be retained within latch 24. In some embodiments, two sets of hinge apertures 88 are provided which provide for connection of first and second hinges 58, 68 between door 20 and first panel 30 to fix the centering relationship which assures free easy movement of door 20 between the open and the closed positions within first aperture 34. It is noted that in some embodiments the area of door 20 can be modified, requiring as few as one of more than two hinges. The quantity and design of the hinge(s) along with the dimensions of the door 20 determines the quantity and location of hinge apertures 88.

First panel 30 further includes an upper mount fastener aperture 90, positioned below door 20 as viewed in FIG. 3, which is provided for fastener support of upper mount 62. A lower mount fastener aperture 92 is provided below upper mount fastener aperture 90 to fastenably support lower mount 64. To support attachment device 66, in some embodiments a pair of attachment device fastener apertures 94 are provided. It is noted that any or all of fastener apertures 84, 86, 88, 90, 92, and 94 can be eliminated if the individual components are for example adhesively attached to first panel 30 or molded into first panel 30 instead of fastenably attached. The sizes of the fastener apertures can vary depending on the type and size of fastener used, for example, screws, bolts, bolt-screws and/or rivets can be used, any of which could require a different aperture size.

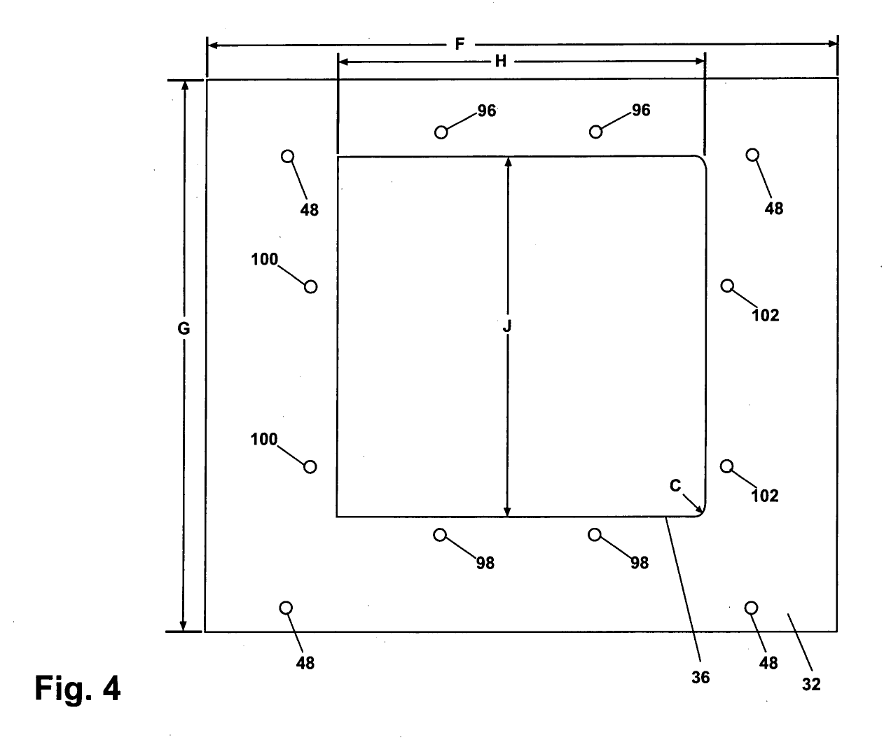

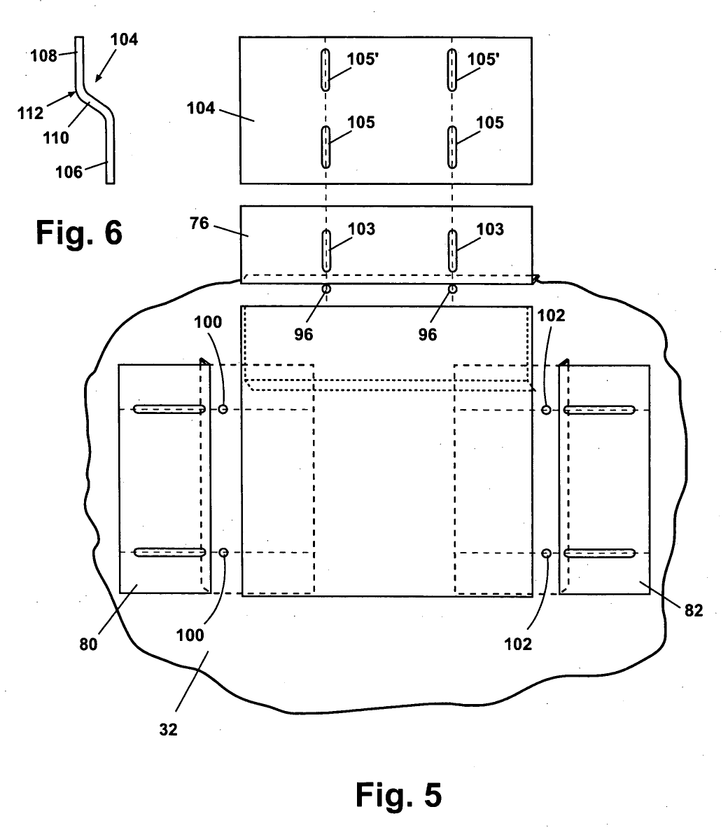

Referring generally now to FIG. 4, second panel 32 having second aperture 36 includes a second panel length “F” and a second panel width “G”. In some embodiments second panel length “F” substantially equals first panel length “A”, and second panel width “G” substantially equals first panel width “B”. Second panel 32 is positioned so that each alignment aperture 48 coaxially aligns with one of the receiving apertures 50 of first panel 30. Second panel 32 further includes first, second, third, and fourth shutter apertures 96, 98, 100, and 102. Shutter apertures 96, 98, 100, and 102 allow each of the shutter elements 76, 78, 80, and 82 to be adjustably installed using slots provided in each of the shutter elements which will be discussed in greater detail in reference to FIG. 5. Second aperture 36 includes a second aperture length “H” and a second aperture width “J”. In some embodiments second aperture length “H” is substantially equal to first aperture length “D” and second aperture width “J” is substantially equal to first aperture width “E”. Corner radius “C” can also be provided in selected ones of the corners of second aperture 36 similar to those provided with first aperture 34.

Referring now to FIGS. 5 and 6, installation and adjustment of the various shutters in shown. Second shutter element 78 is not shown for clarity but is identical to first shutter element 76. Each of the shutter elements including first shutter element 76, third shutter element 80 and fourth shutter element 82 include a pair of slots which are spaced to correspond to the appropriate shutter apertures provided in second panel 32. For example, first shutter element 76 includes slots 103 which are substantially parallel to each other and align with selected ones of first shutter apertures 96. Fasteners installed through second panel 32 and each of first shutter apertures 96 and slots 103 fastenably engage first shutter element 76 to second panel 32. Fasteners can be self-locking or if necessary oriented to prevent loosening by an animal (species dependent). By partially loosening the individual fasteners, any or all of the shutter elements can be moved over a range of positions limited by the length of the individual slots. This permits a cross-sectional open area associated with second aperture 36 to be controlled to individually accommodate a plurality of animal species and sizes and their specialized methods of feeding up to the maximum area provided by second aperture 36. In the example animal 12 is a dog but could represent any other ambulatory animal retained within an enclosure. A dog extends head/neck 26 through the enclosure wall structure 16 to access a feeding unit 28. Other species may feed via extending an appendage or specialized feeding device through the shuttered aperture 36. The various shutters of the present invention can be connected to either first or second panel 30, 32.

With further reference to FIG. 6, at least one shutter extension 104 is also provided with animal feeding device 10 and connectable to either first or second panel 30, 32. Shutter extension 104 includes two sets of slots 105, 105′. Use of shutter extension 104 permits one of the shutter elements, for example first shutter element 76, to extend still further into second aperture 36, providing still further reduction of the open cross-sectional area associated with second aperture 36. Shutter extension 104 includes a first leg 106 and a second leg 108 offset from first leg 106 by a stepped section 110. Offsetting second leg 108 from first leg 106 permits second leg 108 to overlay the selected shutter element. In some embodiments, a diamond patterned metal material is used for the shutter elements and second panel 32. When this material is used, the diamond pattern is positioned on a pattern side 112 which is positioned facing toward the animal and therefore toward the interior area of animal enclosure 14. This permits the shutter elements and shutter extension 104 to be slidably repositioned.

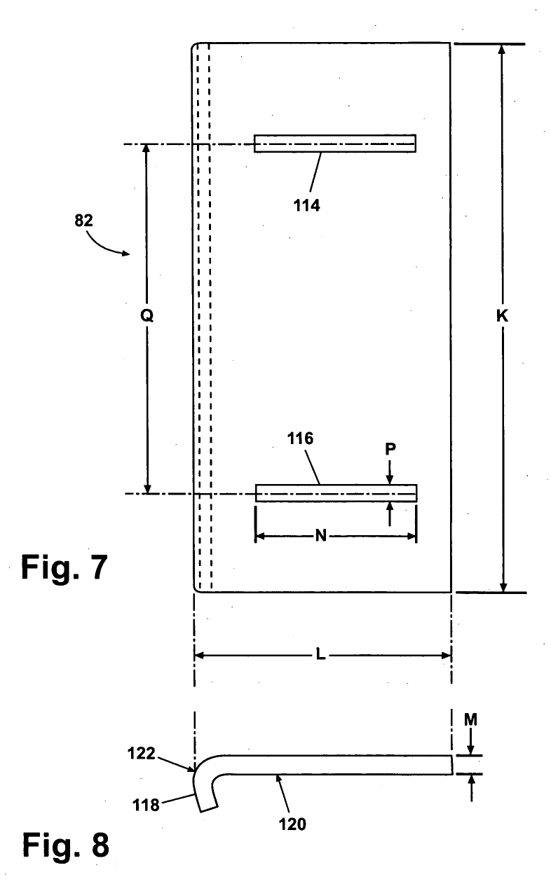

Referring now to FIGS. 7 and 8, exemplary details of fourth shutter element 82 are provided. These details represent the general construction of each of the shutter elements, although dimensions can be varied between the shutter elements. Fourth shutter element 82 includes a first slot 114 and a second slot 116, the two slots 114, 116 being arranged substantially in parallel with each other. A shutter leg 118 defines a greater than 90-degree bend section. When the diamond pattern metal material is used, a shutter pattern side 120 is provided proximate to shutter leg 118. The position of shutter pattern side 120 provides a substantially smooth surface 122. Shutter leg 118 is oriented toward the animal as the animal's head/neck 26 enters second aperture 36. This orients smooth surface 122 to predominantly contact the animal's skin during entry and exit. Animals generally approach door 20 cautiously, therefore there is reduced chance for injury at the leading edge of shutter leg 118 during entry. However, if an animal becomes irritated or frightened their normal reaction is to rapidly withdraw their head and neck from the shuttered aperture with the potential for injury from a sharp leading edge of a shutter damaging the skin in the absence of shutter leg 118. Smooth surface 122 is therefore oriented to contact the skin to permit the animal 12 to withdraw suddenly and rapidly without the skin catching a sharp leading edge of the shutter. Fourth shutter element 82 also includes a shutter length “K”, a shutter width “L” and a shutter thickness “M” which can be varied to accommodate different sizes of second aperture 36. Each of the slots 114, 116, includes a slot length “N” and a slot width “P” which also can vary depending on the shutter width “L” and the size of the fasteners used. A slot spacing “Q” coincides with the center-to-center spacing between the associated shutter apertures.

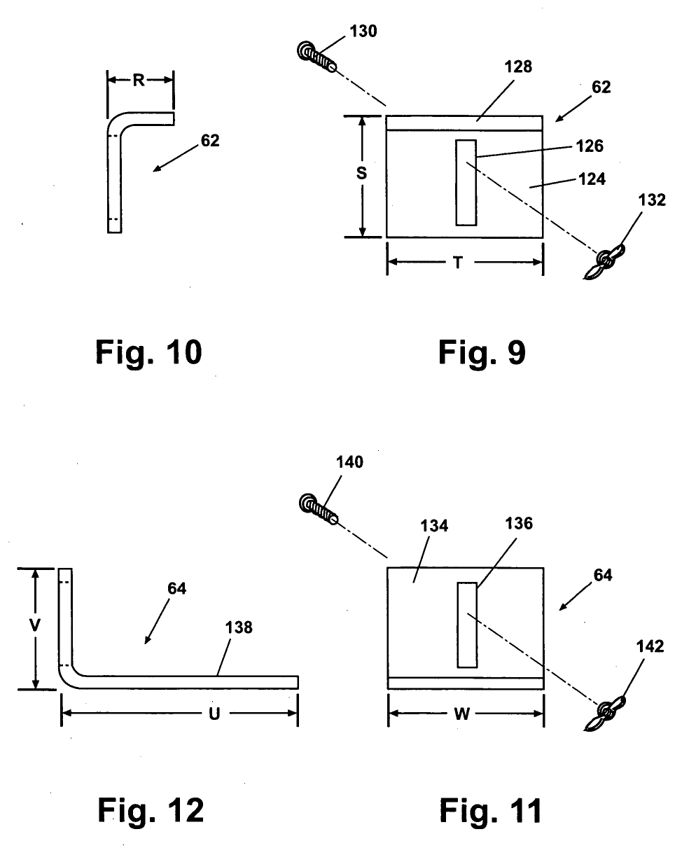

Referring now to FIGS. 9 and 10, upper mount 62 includes an upper mount body 124, which is positionable against first panel 30, and a slot 126, which is alignable with upper mount aperture 90 of first panel 30. An upper mount leg 128 is created at a substantially right angle to upper mount body 124 to provide a retention feature for open end wall 70 of animal feeding unit 68. Upper mount leg 128 has a length “R” and upper mount 62 has a height “S” and a body width “T” which can be varied to accommodate smaller or larger animal feeding units 68. Upper mount 62 is installed on first panel 30 using a fastener 130 extending through upper mount aperture 90 and through slot 126. A retainer 132 such as a wing nut shown can be used to movably and fastenably engage upper mount 62 to first panel 30. Other designs for fasteners 130 and retainer 132 can also be used, and retainer 132 can also be eliminated depending on the type of fastener 130 used.

As best seen in reference to FIGS. 11 and 12, lower mount 64 includes a lower mount body 134, a slot 136 and a lower mount leg 138. Lower mount leg 138 is oriented at a substantially right angle to lower mount body 134 similar to the orientation of upper mount leg 128. Lower mount leg 138 includes a leg length “U” which in some embodiments is greater than leg length “R” of upper mount 62. Use of an increased leg length “U” provides for at least partial bottom support of animal feeding unit 68. Lower mount body 134 includes a body length “V” and a body width “W”. Body width “W” in some embodiments is substantially equal to body width “T” of upper mount 62. Similar to upper mount 62, lower mount 64 is fastenably connected to first panel 30 using a fastener 140 and a retainer 142. Slot 136 performs a similar function to slot 126 allowing lower mount 64 to be adjusted vertically as viewed in FIG. 11 to accommodate different sizes of animal feeding unit 68.

Materials for animal feeding device 10 for those components directed toward the animal facing side of animal enclosure 14 can be a metal material such as steel or aluminum which can be further reinforced with raised diamond patterns to increase material strength. Use of a metal material in these applications reduces the possibility of damage by animals 12. Polymeric material can also be used for these components. In several embodiments, first panel 30 is provided of a polymeric material which provides a lightweight door 20 and provides an easily cleanable surface proximate to the animal feeding unit 68. Polymeric materials having general characteristics of impact resistance and resistance to ultraviolet light degradation can be used, including but not limited to ABS, polymethacrylate, high impact poly-styrene, and the like. Alternate materials can also be used for first panel 30 including metal materials or composite materials. Material for upper and lower mounts 62, 64 in several embodiments is the same material used for second panel 32, but can also be selected to reduce weight or stiffen the mounts as necessary. Latch bar 22 and latch 24 are similar to commercially available gate latches known in the art and can be provided of a metal or a polymeric material. In some embodiments, latch 24 is a gravity engaging latch which provides a manual release lever for releasing latch bar 22 but which requires no manual action to engage latch bar 22 when door 20 is closed. Fastener installation as described herein can also be reversed with the retaining elements installed on the animal facing side of animal enclosure 14.

In other embodiments (not shown), the hinge(s) of door 20 can be biased toward the closed position (not automatically latched closed) and can be displaced by the animal when the animal needs food or water. A spring or similar biasing element, or gravity closed-door design can be used to provide the closing force. The latch can then be selectively positioned to latch door 20 closed (to allow for filling food or for cleaning) or positioned to permit the animal to open door 20.

An animal feeder of the present invention provides several advantages. By creating an aperture in the containment wall of an animal enclosure and providing a door accessible from outside the enclosure, an animal can be fed without direct contact with the animal or entering the enclosure. Aperture shutter elements permit the cross sectional area of the aperture to be adjusted for varying sizes of animals, while preventing the animal from escaping through the aperture when the door is open. A feeding unit such as a food bowl is releasably mounted below the door to permit the unit to be easily removed, cleaned and/or filled. The door can be latched closed when the feeding unit is being filled or removed to further isolate the animal from the operator or locked open to allow continuous access to food or water. Permanently fixing the relationship between the feed container unit and the exterior panel aperture provides unlimited choice of an installation height for each feed/water unit which can further separate a plurality of animal species and animal sizes during feeding while sharing the same enclosure. Materials and construction of the animal feeder are selected to protect the animal and provide for easier cleaning while also providing durability to withstand persistent destructive animal behavior and resistance to environmental degradation, including ultraviolet light degradation.

The description of the invention is merely exemplary in nature, and, thus variations that do not depart from the gist of the invention are intended to be within the scope of the invention. Such variations are not to be regarded as a departure from the spirit and scope of the invention.

What is claimed is:

1. An animal feeding device adaptable for connection to an animal enclosure, comprising:
a first panel having a first aperture alignable with an access aperture created in the enclosure, the first panel mounted on the animal enclosure; and
a closing device moveably mounted on the first panel, the closing device alignable in a first position to at least partially close the first aperture, the closing device defining an opening permitting one of a portion of an animal and a feeding tool to extend therethrough when the closing device is in a second position that is open relative to the first position.

2. The animal feeding device of claim 1, further comprising:
a door defining the closing device;
an outward facing side of the animal enclosure having the first panel mounted thereon;
at least one hinge operable to rotatably mount the door to the first panel for rotation outward from the outward facing side of the enclosure; and
a latch operable to releasably retain the door in the first position.

3. The animal feeding device of claim 2, wherein the latch further comprises:
a first member connected to the door; and
a second member connected to the first panel;
wherein one of the first and second members is adapted to be received and releasably retained by the other of the first and second members; and
wherein the latch is operably lockable in each of the first and the second positions.

4. The animal feeding device of claim 2, further comprising a second latch operable to releasably retain the door in the second position.

5. The animal feeding device of claim 1, further comprising a second panel having a second aperture alignable with both the first aperture and the access aperture, the second panel being positionable on an inward facing side of the animal feeding enclosure opposite from the first panel and connectible to the first panel.

6. The animal feeding device of claim 5, further comprising a movable shutter device operable to selectively limit access through a portion of one of the apertures.

7. The animal feeding device of claim 6, wherein the shutter device further comprises:
a first shutter element movably connectable to the second panel proximate to the second aperture; and
a second shutter element movably connectable to the second panel and positioned oppositely across the second aperture from the first shutter element and proximate to the second aperture;
wherein the first and second shutter elements are movable one of toward and away from each other.

8. The animal feeding device of claim 7, wherein the shutter device further comprises a third and a fourth shutter element both slidably connectable to the second panel and oppositely positionable from each other about the second aperture and positioned for substantially transverse movement relative to the first and second shutter elements.

9. The animal feeding device of claim 8, wherein each of the first, second, third and fourth shutter elements further comprise a rounded end having a rounded surface positionable proximate the second aperture and oriented toward the one of the portion of the animal and the feeding tool when withdrawn through the second aperture.

10. The animal feeding device of claim 7, further comprising an extension element positionable between the second panel and a selected one of the shutter elements, operable to further extend the selected one of the shutter elements into the second aperture.

11. The animal feeding device of claim 1, further comprising an attachment device connectable to the first panel proximate the closure device and operable to releasably support an animal feeding unit.

12. The animal feeding device of claim 11, wherein the attachment device further comprises a flexible member operable to elastically bias the animal feeding unit toward the first panel.

13. The animal feeding device of claim 11, further comprising a mounting device connectable to the first panel below the closure device and proximate to the animal feeding unit, the mounting device operable to retain the animal feeding unit at a predetermined position relative to the closure device.

14. The animal feeding device of claim 13, wherein the mounting device further comprises:
a first bracket positioned to contact an open end wall of the animal feeding unit; and
a second bracket positioned to at least partially support an end surface of the animal feeding unit.

15. An animal feeding device for an animal enclosure, comprising:
an opening in the enclosure;
a closing mechanism having a first position filling at least a portion of the opening and a second position open with respect to the second position; and
a container outside of the enclosure and disposed proximate the opening whereby an animal in the enclosure accesses the container via the opening in the second position while the closing mechanism in the first position prevents egress of the animal from the enclosure.

16. The animal feeding device of claim 15, further comprising:
a door defining the closing mechanism; and
a latch operable to releasably retain the door in the first position.

17. The animal feeding device of claim 16, wherein the door further comprises a hinge operable to permit rotation of the door.

18. The animal feeding device of claim 15, further comprising:
a first panel disposed on an outward facing side of the enclosure having a second opening alignable with the opening in the enclosure; and
a second panel oppositely disposed from the first panel on an inward facing side of the enclosure having a third opening alignable with both the opening in the enclosure and the second opening.

19. The animal feeding device of claim 18, further comprising at least one shutter element movably mounted to one of the first and second panels, the shutter element operable to fill a second portion of the opening.

20. The animal feeding device of claim 18, further comprising:
a latch operable to releasably retain the door in the first position, the latch including:
a first member connected to the door; and
a second member connected to the first panel;
wherein one of the first and second members is adapted to be received and releasably retained by the other of the first and second members; and
wherein the latch is operably lockable in each of the first and the second positions.

21. An animal feeding system, comprising:
a first panel connectable to an exterior facing side of a containment wall of an animal enclosure, the first panel including a first aperture alignable with an access aperture created in the containment wall;
a second panel having a second aperture alignable with both the first aperture and the access aperture, the second panel being positionable on an opposite interior facing side of the outer containment wall from the first panel and fastenably connectable through the containment wall to the first panel;
a mounting device connectable to the first panel below the door and operable to releasably support an animal feeding unit; and
at least one aperture shutter slidably connected to one of the first and second panels, the aperture shutter operable to vary an area of one of the first and second apertures.

22. The system of claim 21, further comprising a door moveably mounted on the first panel, the door aligned in a closed position to substantially cover the first aperture, and aligned in an open position to permit one of a portion of an animal and a feeding tool to extend through each of the first, second and access apertures to permit feeding the animal from the exterior facing side of the animal feeding enclosure.

23. The system of claim 22, further comprising a latch operable to releasably retain the door in the closed position, the latch including:
a first member connected to the door; and
a second member connected to the first panel;
wherein one of the first and second members is adapted to be received and releasably retained by the other of the first and second members.

24. The system of claim 22, further comprising at least one hinge operable to rotatably mount the door to the first panel.

25. An animal feeding system, comprising:
a first panel connectable to an exterior facing side of a containment wall of an animal enclosure, the first panel including a first aperture alignable with an access aperture created in the containment wall;
a second panel having a second aperture alignable with both the first aperture and the access aperture, the second panel being positionable on an opposite interior facing side of the outer containment wall from the first panel and fastenably connectable through the containment wall to the first panel;
a door moveably mounted on the first panel, the door aligned in a closed position to substantially cover the first aperture, and aligned in an open position to permit one of a portion of an animal and a feeding tool to extend through both the first aperture, the second aperture and the access aperture to permit feeding the animal from a first panel side of the animal feeding enclosure;
an attachment device connectable to the first panel below the door and operable to releasably support an animal feeding unit; and
at least one aperture shutter slidably connected to the second panel proximate to the second aperture, the aperture shutter operable to vary a cross sectional area of the second aperture.

26. The system of claim 25, wherein each of the first and second panels comprise one of a polymeric and metal material.

27. The system of claim 25, wherein the attachment device comprises an elastically deflectable polymeric strap.

28. The system of claim 25, wherein the first panel comprises a polymeric material and the second panel comprises a metal material.

29. A method for modifying an animal enclosure to permit feeding an animal from an exterior facing side of a containment wall of the animal enclosure using a first panel having a first aperture, a second panel having a second aperture, a mounting device and an aperture shutter, the method comprising:
creating an access aperture in the containment wall;
positioning the first panel on the exterior facing side of the containment wall to align the first aperture with the access aperture;
locating the second panel on an opposite interior facing side of the outer containment wall from the first panel having the first aperture, the second aperture and the access aperture being in co-alignment;
fastenably connecting the first and second panels through the containment wall; and
releasably connecting an animal feeding unit to the first panel.

30. The method of claim 29, further comprising repeating each of the creating, positioning, locating, fastenably connecting and releasably connecting steps to operably position a plurality of animal feeding devices on the containment wall.

31. The method of claim 30, further comprising varying an elevation of at least two of the plurality of animal feeding devices.

32. The method of claim 29, further comprising:
slidably connecting the aperture shutter to one of the first and second panels; and
adjusting the aperture shutter to vary a cross sectional area of the second aperture.
